(19) United States
(12) Patent Application Publication
(10) Pub. No.: US 2026/0103173 A1
(43) Pub. Date: Apr. 16, 2026

(54) BRAKE SYSTEM AND METHOD OF CONTROLLING THE SAME

(71) Applicant: HL MANDO CORPORATION, Pyeongtaek (KR)

(72) Inventor: Jaehoon JANG, Pyeongtaek (KR)

(21) Appl. No.: 19/027,568

(22) Filed: Jan. 17, 2025

(30) Foreign Application Priority Data
Oct. 15, 2024 (KR) 10-2024-0140695

(51) Int. Cl. B60T 8/1755; B60T 8/58; F16D 55/226; F16D 65/18; F16D 121/24; F16D 125/40

(52) U.S. Cl. CPC B60T 8/1755; B60T 8/58; F16D 55/226; F16D 65/18; B60T 2220/03; B60T 2240/00; B60T 2250/00; B60T 2250/03; F16D 2121/24; F16D 2125/40

(57) ABSTRACT

A brake system may include a piston configured to advance or retract and configured to press a pad plate so that the pad plate is in contact with a brake disc configured to rotate together with a wheel, a motor configured to generate a rotational force for operating the piston, and a controller configured to control the motor, in which the controller is configured to control the motor to move a position of the piston to increase a clearance between the pad plate and the brake disc to a first reference clearance, and control the motor to move the position of the piston to decrease the clearance to a second reference clearance smaller than the first reference clearance based on a steering angle, a steering angular velocity, a lateral acceleration, a longitudinal acceleration, and/or a yaw rate of the vehicle.

### CROSS-REFERENCE TO RELATED APPLICATIONS

This application claims the priority of Korean Patent Application No. 10-2024-0140695 filed on Oct. 15, 2024, in the Korean Intellectual Property Office, the disclosure of which is incorporated herein by reference.

### BACKGROUND

### Field

The disclosed disclosure relates to a brake system and a method of controlling the same.

### Description of the Related Art

An electromechanical brake generates a braking force by means of a frictional force between a brake disc and a pad plate.

The frictional force between the brake disc and the pad plate may be generated as the pad plate is moved and brought into contact with the brake disc by hydraulic pressure generated when a driver of a vehicle presses a brake pedal.

After the operation of braking the vehicle is ended, the brake disc and the pad plate are separated from each other by knock-back between the brake disc and the pad plate and by a restoring force of a piston seal (roll-back), such that the frictional force is eliminated.

In the related art, there sometimes occurs a drag phenomenon in which the brake disc and the pad plate are not completely separated when the brake disc and the pad plate are separated. For this reason, there occurs a problem in that unnecessary friction shortens a lifespan of the pad plate and hinders the operation of the vehicle.

Therefore, a technology is being developed to control a position of the pad plate to remove the occurrence of the drag phenomenon caused by abnormal contact between the brake disc and the pad plate when the braked state is released.

### SUMMARY

An object to be achieved by the present disclosure is to provide a brake system and a method of controlling the same, which are capable of providing quick braking responsiveness, in a situation in which braking stability of a vehicle is required, while controlling a position of a pad plate to remove the occurrence of a drag phenomenon caused by abnormal contact between a brake disc and the pad plate.

For example, the brake system and the method of controlling the same may solve the problem in which responsiveness of a brake system is decreased in case that braking or posture control for the vehicle is urgently required to ensure traveling and/or braking stability or the like of the vehicle during a process of controlling the position of the pad plate of the brake system for the purpose of zero drag.

One aspect of the disclosed disclosure provides a brake system including: a piston configured to advance or retract and configured to press a pad plate so that the pad plate is in contact with a brake disc configured to rotate together with a wheel; a motor configured to generate a rotational force for operating the piston; a ball screw configured to convert a rotational motion of the motor into a rectilinear motion to operate the piston; and a controller configured to control the motor, in which the controller may control the motor to move a position of the piston to increase a clearance between the pad plate and the brake disc to a first reference clearance, and control the motor to move the position of the piston to decrease the clearance to a second reference clearance smaller than the first reference clearance on the basis that at least one of a steering angle, a steering angular velocity, a lateral acceleration, a longitudinal acceleration, or a yaw rate of the vehicle is greater than a predesignated reference value.

The controller may control the motor to move the position of the piston to increase the clearance to the first reference clearance on the basis that a deceleration or an acceleration of the wheel, which is acquired from a signal received from a wheel speed sensor of the wheel, is greater than a corresponding reference value of predesignated deceleration and acceleration reference values in a coast speed reduction situation of the vehicle.

The controller may control the motor to move the position of the piston to increase the clearance to the first reference clearance based on determination of a drag occurrence of the brake system when the deceleration or the acceleration of the wheel is greater than the corresponding reference value.

The controller may control the motor to move the position of the piston to decrease the clearance to the second reference clearance on the basis that the state in which at least one of the steering angle, the steering angular velocity, the lateral acceleration, the longitudinal acceleration, or the yaw rate of the vehicle is greater than the reference value is maintained for a reference time interval or more.

The controller may determine that electronic stability control of the vehicle is likely to be performed on the basis that at least one of the steering angle, the steering angular velocity, the lateral acceleration, the longitudinal acceleration, or the yaw rate of the vehicle is greater than the reference value.

The controller may increase a count value on the basis that at least one of the steering angle, the steering angular velocity, the lateral acceleration, the longitudinal acceleration, or the yaw rate of the vehicle is greater than the reference value during control of the motor to move the position of the piston to increase the clearance to the first reference clearance, and control the motor to move the position of the piston to decrease the clearance to the second reference clearance on the basis of the increased count value.

The controller may control the motor to move the position of the piston to decrease the clearance to the second reference clearance on the basis that the increased count value is greater than a predesignated first reference count value, and control the motor to move the position of the piston on the basis of a deceleration or acceleration of the wheel acquired from a signal received from a wheel speed sensor of the wheel on the basis that the increased count value is equal to or smaller than the predesignate first reference count value.

The controller may control the motor to maintain the clearance as the first reference clearance on the basis that the increased count value is greater than a predesignated second reference count value that is a value greater than the predesignate first reference count value, and control the motor to move the position of the piston to decrease the clearance to the second reference clearance on the basis that the increased count value is greater than the predesignate first reference count value and equal to or smaller than the predesignate second reference count value.

The controller may determine urgency of the electronic stability control as a first level on the basis that the increased count value is greater than the predesignated first reference count value and equal to or smaller than a predesignated second reference count value, and determine the urgency of the electronic stability control of the vehicle as a second level higher than the first level on the basis that the increased count value is greater than the predesignated second reference count value that is a value greater than the predesignate first reference count value.

The controller may control the motor to maintain the clearance as the first reference clearance on the basis that the urgency of the electronic stability control of the vehicle is determined as the second level, and control the motor to move the position of the piston to decrease the clearance to the second reference clearance on the basis that the urgency of the electronic stability control of the vehicle is determined as the first level.

Another aspect of the disclosed disclosure provides a method of controlling a brake system, the method including: controlling a motor of an electromechanical brake to move a position of a piston of the electromechanical brake to increase a clearance between a pad plate and a brake disc of the electromechanical brake to a first reference clearance; and controlling the motor to move the position of the piston to decrease the clearance to a second reference clearance smaller than the first reference clearance on the basis that at least one of a steering angle, a steering angular velocity, a lateral acceleration, a longitudinal acceleration, or an yaw rate of the vehicle is greater than a predesignated reference value.

The controlling of the motor to move the position of the piston to increase the clearance to the first reference clearance may be performed on the basis that a deceleration or an acceleration of a wheel acquired from a signal received from a wheel speed sensor of the wheel is greater than a corresponding reference value of predesignated deceleration and acceleration reference values in a coast speed reduction situation of the vehicle.

The controlling of the motor to move the position of the piston to increase the clearance to the first reference clearance may be performed on the basis that a drag occurrence of the brake system when the deceleration or the acceleration of the wheel is greater than the corresponding reference value.

The controlling of the motor to move the position of the piston to decrease the clearance to the second reference clearance may be performed on the basis that the state in which at least one of the steering angle, the steering angular velocity, the lateral acceleration, the longitudinal acceleration, or the yaw rate of the vehicle is greater than the reference value is maintained for a preset time interval or more.

The method of controlling the brake system may further include: determining that electronic stability control of the vehicle is likely to be performed on the basis that at least one of the steering angle, the steering angular velocity, the lateral acceleration, the longitudinal acceleration, or the yaw rate of the vehicle is greater than the reference value. The controlling the motor to move the position of the piston to decrease the clearance to the second reference clearance may include: increasing a count value on the basis that at least one of the steering angle, the steering angular velocity, the lateral acceleration, the longitudinal acceleration, or the yaw rate of the vehicle is greater than the reference value during control of the motor to move the position of the piston to increase the clearance to the first reference clearance; and controlling the motor to move the position of the piston so that the clearance becomes the second reference clearance on the basis of the increased count value.

The controlling the motor to move the position of the piston to decrease the clearance to the second reference clearance may be performed on the basis that the increased count value is greater than a predesignated first reference count value, and the method of controlling the brake system may further include performed on the basis that the increased count value is greater than a predesignated first reference count value.

The method of controlling the brake system may further include: controlling the motor to maintain the clearance as the first reference clearance on the basis that the increased count value is greater than a predesignated second reference count value that is a value greater than the first reference count value, in which the controlling the motor to move the position of the piston to decrease the clearance to the second reference clearance is performed on the basis that the increased count value is greater than the predesignate first reference count value and equal to or smaller than the predesignate second reference count value.

The method of controlling the brake system may further include: determining urgency of the electronic stability control as a first level on the basis that the increased count value is greater than the predesignate first reference count value and equal to or smaller than a predesignated second reference count value; and determining the urgency of the electronic stability control of the vehicle as a second level higher than the first level on the basis that the increased count value is greater than the predesignated second reference count value that is a value greater than the predesignate first reference count value.

The method of controlling the brake system may further include: controlling the motor to maintain the clearance as the first reference clearance on the basis that the urgency of the electronic stability control of the vehicle is determined as the second level, in which the controlling the motor to move the position of the piston to decrease the clearance to the second reference clearance may be performed on the basis that the urgency of the electronic stability control of the vehicle is determined as the first level.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a connection structure of a brake system according to an embodiment;

FIGS. 2 and 3 are views illustrating an electromechanical brake of the brake system according to the embodiment;

FIG. 4 is a block diagram of a vehicle including the brake system according to the embodiment;

FIG. 5 is a flowchart of an operation of the brake system according to the embodiment;

FIGS. 6A and 6B are flowcharts of the operation of the brake system according to the embodiment; and

FIG. 7 is a flowchart of the operation of the brake system according to the embodiment.

### DETAILED DESCRIPTION OF THE EMBODIMENT

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

The disclosed disclosure may provide a brake system and a method of controlling the same that may control a pad clearance to ensure a predetermined clearance between a pad plate and a brake disc of an electromechanical brake (EMB) in a situation in which a vehicle is accelerated by an accelerator pedal.

In addition, the disclosed disclosure may provide the brake system and the method of controlling the same that may adjust the clearance between the pad plate and the brake disc regardless of the brake pedal by recognizing in advance a situation in which the electronic traveling stability of the vehicle is required to be controlled in a situation in which the clearance between the pad plate and the brake disc of the electromechanical brake is increased.

For example, the disclosed disclosure may provide the brake system and the method of controlling the same that may adjust the clearance between the pad plate and the brake disc regardless of the brake pedal by recognizing in advance a situation in which the braking is required to be controlled, regardless of the brake pedal, by a steering angle state of the vehicle and/or vehicle attitude feedback (VaF) of other steering and suspension devices.

Hereinafter, operation principles and embodiments of the disclosed disclosure will be described in detail with reference to the accompanying drawings.

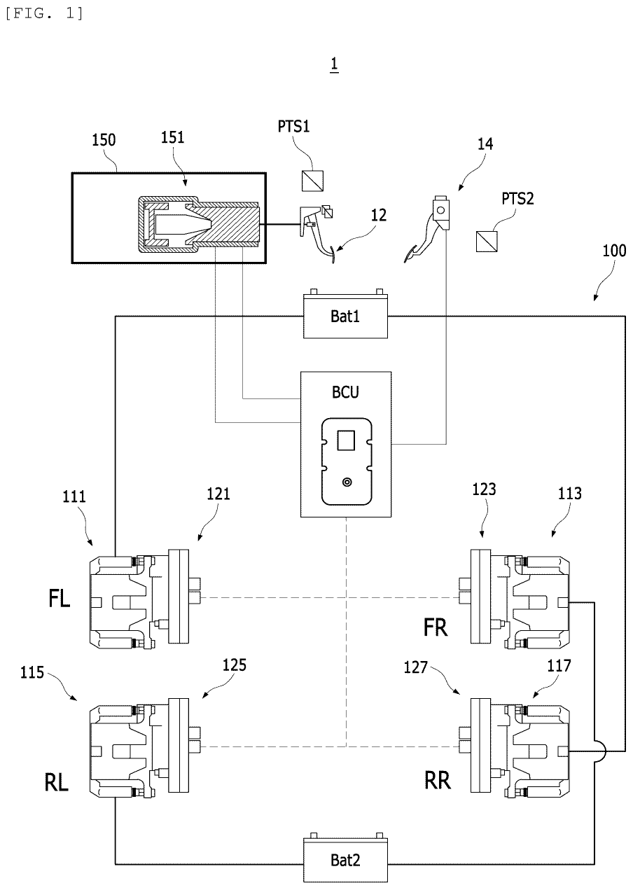

FIG. 1 is a view illustrating a connection structure of a brake system according to an embodiment.

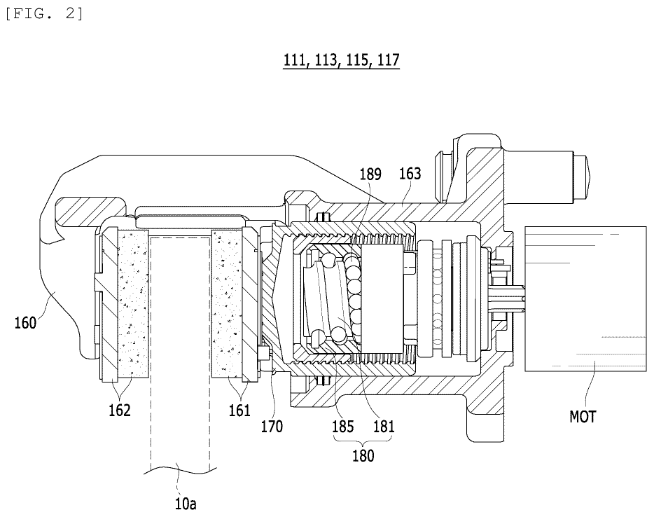

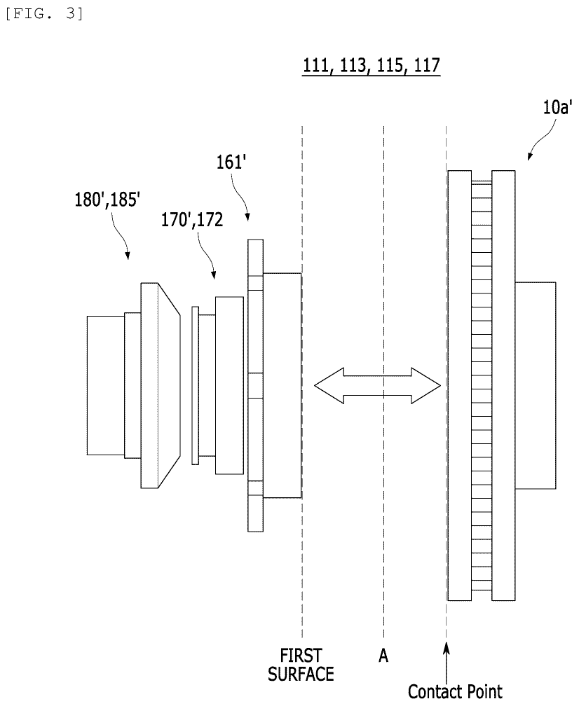

FIGS. 2 and 3 are views illustrating an electromechanical brake of the brake system according to the embodiment.

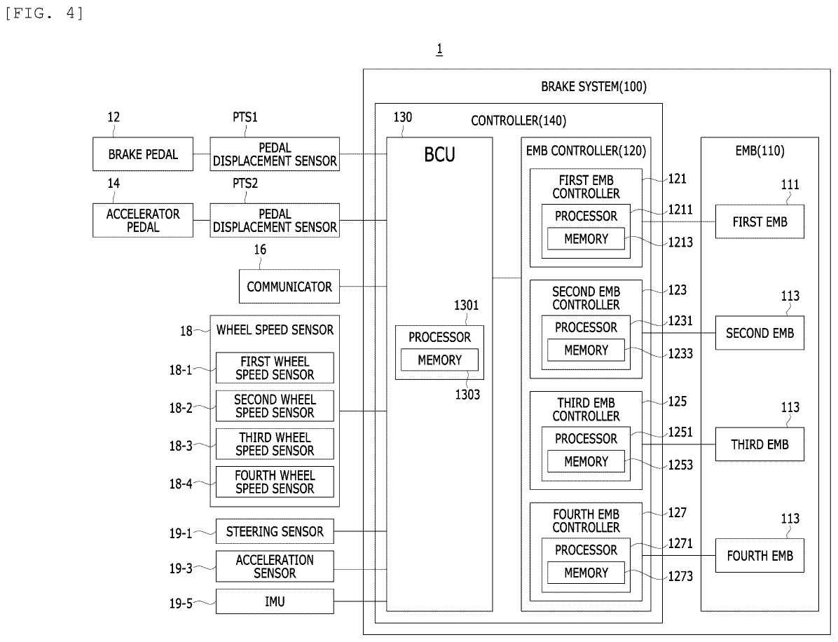

FIG. 4 is a block diagram of a vehicle including the brake system according to the embodiment.

With reference to FIG. 1, a brake system 100 of a vehicle 1 may include one or more electromechanical brakes (EMBs), for example, first to fourth electromechanical brakes 111, 113, 115, and 117.

The first to fourth electromechanical brakes 111, 113, 115, and 117 may be respectively provided (or installed) in the wheels FL, FR, RL, and RR of the vehicle 1 and brake the vehicle 1 by braking the corresponding wheels FL, FR, RL, and RR.

For example, the first electromechanical brake 111 may be provided in the left front wheel FL and brake the left front wheel FL. In addition, the second electromechanical brake 113 may be provided in the right front wheel FR and brake the right front wheel FR. In addition, the third electromechanical brake 115 may be provided in the left rear wheel RL and brake the left rear wheel RL. In addition, the fourth electromechanical brake 117 may be provided in the right rear wheel RR and brake the right rear wheel RR.

For example, the first to fourth electromechanical brakes 111, 113, 115, and 117 may each include a caliper brake 110 illustrated in FIG. 2.

The caliper brake 110 may include a pair of pad plates 161 and 162 installed to press a brake disc 10a configured to rotate together with each of the wheels FL, FR, RL, and RR, a caliper housing 160 configured to operate the pair of pad plates 161 and 162, a piston 170 installed in the caliper housing 160 and configured to advance or retract, a power conversion unit 180 configured to receive rotational driving power for moving the piston 170, convert the rotational driving power into linear driving power, and transmit the linear driving power to the piston 170, and/or a brake motor MOT (or also referred to as a “motor M”) configured to generate rotational driving power for moving the piston 170.

The piston 170 may be provided in a cup shape opened at the rear side and slidably inserted into a cylinder part 163. In addition, the piston 170 may press the inner pad plate 161 toward the brake disc 10a by receiving power through the power conversion unit 180.

The power conversion unit 180 may include a spindle 181 configured to rotate by receiving driving power from the motor MOT, a nut 185 disposed in the piston 170, screw-connected to the spindle 181, and configured to be advanced together with the piston 170 by a rotation of the spindle 181 in a first direction or retracted together with the piston 170 by a rotation of the spindle 181 in a second direction, and/or a plurality of balls 189 interposed between the spindle 181 and the nut 185. The power conversion unit 180 may be provided as a ball-screw type conversion device configured to convert a rotational motion of the spindle 181 into a linear motion.

A rotational motion of the motor MOT may be converted into a linear motion of the piston 170 by the power conversion unit 180. The pair of pad plates 161 and 162 may be compressed toward the brake disc 10a by the linear motion of the piston 170, and the wheels FL, FR, RL, and RR may be braked by friction between the pair of pad plates 161 and 162 and the brake disc 10a.

FIG. 2 illustrates the caliper brake 110 as an example of each of the electromechanical brakes 111, 113, 115, and 117. However, the electromechanical brake is not limited to the caliper brake 110 in FIG. 2.

For example, instead of the structure in FIG. 2 in which the pair of pad plates 161 and 162 presses the brake disc 10a, the first to fourth electromechanical brakes 111, 113, 115, and 117 may each have a structure in which only a single pad plate 161′ is included and the single pad plate 161′presses the brake disc 10a′, as illustrated in FIG. 3.

With reference to FIG. 3, the electromechanical brakes 111, 113, 115, and 117 may each include the single pad plate 161′ configured to press the brake disc 10a′. The pad plate 161′ may be disposed at a distal end of a piston 170′that operates in the same way as the piston 170 in FIG. 2, and the pad plate 161′may come into contact with one surface of a footer 172 provided to apply a force to the pad plate 161′. The other surface of the footer 172 may come into contact with a nut 185′ of a power conversion unit 180′ that operates in the same way as the power conversion unit 180 in FIG. 2.

With reference back to FIG. 1, the brake system 100 may include one or more electromechanical brake control units, e.g., first to fourth electromechanical brake control units 121, 123, 125, and 127.

The first to fourth electromechanical brake control units 121, 123, 125, and 127 may be respectively provided in the electromechanical brakes 111, 113, 115, and 117, and the electromechanical brake control units 121, 123, 125, and 127 may respectively control the corresponding electromechanical brakes 111, 113, 115, and 117.

For example, the first electromechanical brake control unit 121 may be provided in the first electromechanical brake 111 and control the first electromechanical brake 111. In addition, the second electromechanical brake control unit 123 may be provided in the second electromechanical brake 113 and control the second electromechanical brake 113. In addition, the third electromechanical brake control unit 125 may be provided in the third electromechanical brake 115 and control the third electromechanical brake 115. In addition, the fourth electromechanical brake control unit 127 may be provided in the fourth electromechanical brake 117 and control the fourth electromechanical brake 117.

The brake system 100 may include a brake control unit (BCU) 130.

The brake control unit 130 may be provided with signals related to information on wheel speeds of the wheels FL, RL, FR, and RR from respective wheel speed sensors 18-1, 18-3, 18-5, and 18-7.

The brake control unit 130 may communicate with (e.g., by controller area network (CAN) communication connection) or be electrically connected to (e.g., connected, by a hard wire, directly to) a pedal displacement sensor PTS1 physically connected to a brake pedal 12 of the vehicle 1, and the brake control unit 130 may receive an electrical signal from the pedal displacement sensor PTS1.

The brake pedal 12 may acquire a driver's input for braking the vehicle 1.

For example, the brake pedal 12 may be provided at a lower side of a cabin so that the driver may control the brake pedal 12 with his/her foot. The driver may push the brake pedal 12 in accordance with a braking intention to brake the vehicle 1. Therefore, the brake pedal 12 may depart from a reference position and move.

In addition, the brake pedal 12 may be physically connected to a master cylinder 151 of a liquid pressure device 150 capable of generating liquid pressure for generating a braking force in each of the wheels.

For example, in case that the driver applies a pedal effort to the brake pedal 12 to perform the braking operation, the master cylinder 151 may provide stable pedal feel by providing the driver with a reaction force related to the pedal effort. In addition, the master cylinder 151 may be configured to pressurize and discharge the pressing medium accommodated therein by the operation of the brake pedal 12.

The pedal displacement sensor PTS1 may measure a movement of the brake pedal 12 made by the driver's braking intention. For example, the pedal displacement sensor PTS1 may detect a movement distance and/or a movement speed of the brake pedal 12 from a reference position.

The brake control unit 130 may communicate with or be electrically connected to a pedal displacement sensor PTS2 physically connected to an accelerator pedal 14 of the vehicle 1 and receive an electrical signal from the pedal displacement sensor PTS2.

The accelerator pedal 14 may acquire the driver's input for accelerating the vehicle 1.

For example, the accelerator pedal 14 may be provided at the lower side of the cabin so that the driver may control the accelerator pedal 14 with his/her foot. The driver may push the accelerator pedal 14 in accordance with an accelerating intention to accelerate the vehicle 1. Therefore, the accelerator pedal 14 may depart from a reference position and move.

The pedal displacement sensor PTS2 may measure a movement of the accelerator pedal 14 made by the driver's accelerating intention. For example, the pedal displacement sensor PTS2 may detect a movement distance and/or a movement speed of the accelerator pedal 14 from a reference position.

The brake control unit (BCU) 110 may communicate with or be electrically connected to the first to fourth electromechanical brake control units 121, 123, 125, and 127 and control the first to fourth electromechanical brake control units 121, 123, 125, and 127.

For example, in case that the brake control unit 130 communicates with each of the first to fourth electromechanical brake control units 121, 123, 125, and 127, the brake control unit 130 and the first to fourth electromechanical brake control units 121, 123, 125, and 127 may communicate with one another through communication networks between the controllers independently of a communication network of the vehicle 1.

The brake control unit 130 may provide control signals to the electromechanical brake control units 121, 123, 125, and 127 to allow the electromechanical brake control units 121, 123, 125, and 127 to perform control to brake or release the corresponding wheels FL, FR, RL, and RR on the basis of electrical signals provided from the pedal displacement sensor PTS1 and/or the pedal displacement sensor PTS2.

Meanwhile, the components of the brake system 100 may receive power from a battery Bat1 and/or a battery Bat2 corresponding to power sources of the vehicle 1.

With reference to FIG. 4, the vehicle 1 may include the brake pedal 12, the accelerator pedal 14, a communicator 16, wheel speed sensors 18, a steering sensor 19-1, an acceleration sensor 19-3, an inertia measurement unit (IMU) 19-5, the pedal displacement sensor PTS1, the pedal displacement sensor PTS2, and/or the brake system 100.

Because the brake pedal 12, the accelerator pedal 14, the pedal displacement sensor PTS1, and the pedal displacement sensor PTS2 have been described in detail with reference to FIG. 1, a description thereof will be omitted.

The communicator 16 may include a communication circuit configured to communicate with constituent elements (or also referred to as “devices”) of the vehicle 1 through a communication network for a vehicle and/or a communication network between the controllers, and/or a control circuit configured to control an operation of the communication circuit. For example, the constituent elements included in the vehicle 1 may send and receive data through Ethernet, media-oriented system transport (MOST), Flexray, controller area network (CAN), and local interconnect network (LIN).

The wheel speed sensors 18 may include the first wheel speed sensor 18-1, the second wheel speed sensor 18-3, the third wheel speed sensor 18-5, and/or the fourth wheel speed sensor 18-7.

The first to fourth wheel speed sensors 18-1, 18-3, 18-5, and 18-7 may be respectively provided (or installed) in the wheels FL, FR, RL, and RR of the vehicle 1 and measure wheel speeds of the corresponding wheels FL, FR, RL, and RR.

For example, the first wheel speed sensor 18-1 may be provided in the left front wheel FL and measure the wheel speed of the left front wheel FL. In addition, the second wheel speed sensor 18-3 may be provided in the right front wheel FR and measure the wheel speed of the right front wheel FR. In addition, the third wheel speed sensor 18-5 may be provided in the left rear wheel RL and measure the wheel speed of the left rear wheel RL. In addition, the fourth wheel speed sensor 18-7 may be provided in the right rear wheel RR and measure the wheel speed of the right rear wheel RR.

For example, the first to fourth wheel speed sensors 18-1, 18-3, 18-5, and 18-7 may communicate with or be electrically connected to a controller 140 of the brake system 100, e.g., the brake control unit 130 and provide the brake control unit 130 with signals corresponding to the measured wheel speeds.

The steering sensor 19-1 may measure a steering angle of the vehicle 1.

For example, the steering sensor 19-1 may communicate with or be electrically connected to the controller 140 of the brake system 100, e.g., the brake control unit 130 and provide the brake control unit 130 with a signal corresponding to the measured steering angle.

The acceleration sensor 19-3 may measure an acceleration, e.g., a lateral acceleration and/or a longitudinal acceleration of the vehicle 1.

For example, the acceleration sensor 19-3 may communicate with or be electrically connected to the controller 140 of the brake system 100, e.g., the brake control unit 130 and provide the brake control unit 130 with a signal corresponding to the measured acceleration.

The inertia measurement unit 19-5 may include an accelerometer and a gyroscope and measure an acceleration, an angular velocity, a gradient, a yaw rate, a pitch rate, and/or a roll rate of the vehicle 1.

For example, the inertia measurement unit 19-5 may communicate with or be electrically connected to the controller 140 of the brake system 100, e.g., the brake control unit 130 and provide the brake control unit 130 with signals corresponding to the measured acceleration, the measured angular velocity, the measured gradient, the measured yaw rate, the measured pitch rate, and/or the measured roll rate.

The brake system 100 may include the electromechanical brakes 110 and/or the controller 140.

The electromechanical brakes 110 may include the first electromechanical brake 111, the second electromechanical brake 113, the third electromechanical brake 115, and/or the fourth electromechanical brake 117.

Because the electromechanical brake 110 has been described with reference to FIGS. 1 to 3, a description thereof will be omitted.

The controller 140 may include the electromechanical brake control units 120 and/or the brake control unit 130.

On the basis of the control signal of the brake control unit 130, the electromechanical brake control units 120 may perform control to ensure predetermined clearances between the pad plates 161, 162, and 161′and the brake disc 10a or 10a′ of the electromechanical brakes 111, 113, 115, and 117.

The electromechanical brake control units 120 may perform control to ensure the predetermined clearances between the pad plates 161, 162, and 161′ and the brake disc 10a or 10a′ of the electromechanical brakes 111, 113, 115, and 117 by means of a stored algorithm on the basis of the driver's braking intention or accelerating intention and/or state information of a road surface.

With reference to FIG. 3, the electromechanical brake control unit 120 may perform control so that a first surface of the pad plate 161′ of each of the electromechanical brakes 111, 113, 115, and 117 (a surface capable of being in contact with the brake disc 10a′) is positioned at point A spaced apart from a contact point of the brake disc 10a′ at a predetermined interval. For example, the pad plate 161′ may move toward or away from the contact point based on point A.

The electromechanical brake control units 120 may estimate states of the wheels FL, RL, FR, and RR on the basis of information on the wheel speeds of the wheels FL, RL, FR, and RR. The electromechanical brake control unit 120 may perform control to operate the motor MOT to ensure the predetermined clearances between the pad plates 161, 162, and 161′and the brake disc 10a or 10a′ of each of the electromechanical brakes 111, 113, 115, and 117 by estimating the state of each of the wheels FL, RL, FR, and RR.

The electromechanical brake control unit 120 may determine whether a drag occurs on the basis of a torque value generated by the motor MOT during the process of controlling the operation of the motor MOT. In addition, when the electromechanical brake control unit 120 determines that the drag occurs, the electromechanical brake control unit 120 may control the motor MOT to ensure the predetermined clearances between the pad plates 161, 162, and 161′and the brake disc 10a or 10a′ of each of the electromechanical brakes 111, 113, 115, and 117.

The electromechanical brake control unit 120 may determine necessary motion degrees of the pad plates 161, 162, and 161′for controlling electronic traveling stability of the vehicle 1 before, e.g., immediately before electronic stability control (ESC) of the vehicle 1 is performed. The electromechanical brake control unit 120 may control the motor MOT to ensure the predetermined clearances between the pad plates 161, 162, and 161′and the brake disc 10a or 10a′ of each of the electromechanical brakes 111, 113, 115, and 117 before, e.g., immediately before the electronic stability control of the vehicle 1 is performed.

In case that it is determined that a road surface on which the vehicle 1 is traveling is a low-friction road surface, the electromechanical brake control unit 120 may calibrate a reference count value which will be described below and serves as a criterion for determining whether the drag occurs.

The electromechanical brake control units 120 may include the first electromechanical brake control unit 121, the second electromechanical brake control unit 123, the third electromechanical brake control unit 125, and/or the fourth electromechanical brake control unit 127.

The electromechanical brake control units 121, 123, 125, and 127 may actively update the positions of the pad plates 161, 162, and 161′of the electromechanical brakes 111, 113, 115, and 117 by actively updating the positions of the piston 170 or 170′ of the corresponding electromechanical brakes 111, 113, 115, and 117.

The electromechanical brake control units 121, 123, 125, and 127 may each control the operation of the motor MOT of each of the electromechanical brakes 111, 113, 115, and 117 to move the position of the piston 170 or 170′ to increase the clearance between the pad plate and the brake disc 10a or 10a′ to a preset first reference clearance.

For example, the electromechanical brake control units 121, 123, 125, and 127 may each determine whether a deceleration or acceleration of each of the wheels FL, RL, FR, and RR is greater than a corresponding reference value of predesignated deceleration and acceleration reference values in a coast speed reduction situation of the vehicle 1. The electromechanical brake control units 121, 123, 125, and 127 may each determine whether a deceleration of each of the wheels FL, RL, FR, and RR is greater than a predesignated deceleration reference value in a coast speed reduction situatio of the vehicle 1. Also, the electromechanical brake control units 121, 123, 125, and 127 may each determine whether a acceleration of each of the wheels FL, RL, FR, and RR is greater than a predesignated acceleration reference value in a coast speed reduction situatio of the vehicle 1. In addition, in case that the deceleration or acceleration of each of the wheels FL, RL, FR, and RR is greater than the corresponding reference value in the coast speed reduction situation of the vehicle 1, the electromechanical brake control units 121, 123, 125, and 127 may each determine whether a drag of the brake system 100 occurs on the basis of the speed of each of the corresponding wheels FL, RL, FR, and RR having the deceleration or acceleration greater than the reference value. In addition, on the basis that the drag of the brake system 100 occurs, the electromechanical brake control units 121, 123, 125, and 127 may each move the position of the piston 170 or 170′so that the position of the piston 170 or 170′ of each of the corresponding wheels FL, RL, FR, and RR is positioned at a preset point. As the position of the piston 170 or 170′ is moved, the brake disc 10a or 10a′ may be positioned at a point spaced apart from the pad plates 161, 162, and 161′by preset clearances.

The electromechanical brake control units 121, 123, 125, and 127 may each determine whether the electronic stability control of the vehicle 1 is likely to be performed while moving the position of the piston 170 or 170′ to increase the clearance between the pad plates 161, 162, and 161′ and the brake disc 10a or 10a′ to the first reference clearance.

In addition, when the electromechanical brake control units 121, 123, 125, and 127 each determine that the electronic stability control of the vehicle 1 is likely to be performed, the electromechanical brake control units 121, 123, 125, and 127 may each control the operation of the motor MOT of each of the electromechanical brakes 111, 113, 115, and 117 to move the position of the piston 170 or 170′ so that the clearance between the pad plates 161, 162, and 161′ and the brake disc 10a or 10a′ becomes a preset second reference clearance smaller than the first reference clearance.

For example, when the steering angle and the steering angular velocity of the vehicle 1 are greater than reference values while the clearance between the pad plates 161, 162, and 161′ and the brake disc 10a or 10a′ of each of the electromechanical brakes 111, 113, 115, and 117 is controlled to increase from 0.2 mm to 0.5 mm while the vehicle 1 moves on the basis of the pedal effort applied to the accelerator pedal 14, the electromechanical brake control units 121, 123, 125, and 127 may each perform control to decrease the clearance between the pad plates 161, 162, and 161′ and the brake disc 10a or 10a′ to 0.2 mm or 0.1 mm. For example, when the steering angle and/or the steering angular velocity of the vehicle 1 is greater than the reference value, the electronic stability control is likely to be performed.

For example, in case that an urgency level of electronic stability control is a first level, the electromechanical brake control units 121, 123, 125, and 127 may each control the clearance between the pad plates 161, 162, and 161′and the brake disc 10a or 10a′ to 0.2 mm. In addition, in case that the urgency level of electronic stability control is a second level higher than the first level, the electromechanical brake control units 121, 123, 125, and 127 may each control the clearance between the pad plates 161, 162, and 161′ and the brake disc 10a or 10a′ to 0.1 mm.

The first electromechanical brake control unit 121 may include a processor 1211 configured to provide a control signal for controlling an operation of the first electromechanical brake 111.

The processor 1211 may include a memory 1213 configured to store or memorize a program (and/or an algorithm) and data for implementing an operation of controlling the first electromechanical brake 111.

The second electromechanical brake control unit 123 may include a processor 1231 configured to provide a control signal for controlling an operation of the second electromechanical brake 113.

The processor 1231 may include a memory 1233 configured to store or memorize a program and data for implementing an operation of controlling the second electromechanical brake 113.

The third electromechanical brake control unit 125 may include a processor 1251 configured to provide a control signal for controlling an operation of the third electromechanical brake 115.

The processor 1251 may include a memory 1253 configured to store or memorize a program and data for implementing an operation of controlling the third electromechanical brake 115.

The fourth electromechanical brake control unit 127 may include a processor 1271 configured to provide a control signal for controlling an operation of the fourth electromechanical brake 117.

The processor 1271 may include a memory 1273 configured to store or memorize a program and data for implementing an operation of controlling the fourth electromechanical brake 117.

Meanwhile, the above-mentioned memories 1213, 1233, 1253, and 1273 may provide stored programs and data to the corresponding processors 1211, 1231, 1251, and 1271 and memorize temporary data produced during the operations of the corresponding processors 1211, 1231, 1251, and 1271. For example, the memories 1213, 1233, 1253, and 1273 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The brake control unit 130 may provide the electromechanical brake control unit 130 with information on the wheel speeds of the wheels FL, RL, FR, and RR acquired by the wheel speed sensors 18-1, 18-3, 18-5, and 18-7.

The brake control unit 130 may calculate a target value of the electromechanical brake by means of the stored algorithm on the basis of an output signal of the pedal displacement sensor PTS1.

The brake control unit 130 may determine the driver's accelerating intention on the basis of an output signal of the pedal displacement sensor PTS2.

The brake control unit 130 may calculate the steering angle and/or the steering angular velocity of the vehicle 1 by means of the steering sensor 19-1.

The brake control unit 130 may calculate the lateral acceleration, the longitudinal acceleration, and/or the yaw rate of the vehicle 1 in response to the signals received from the acceleration sensor 19-3 and/or the inertia measurement unit 19-5.

On the basis of the steering angle, the steering angular velocity, the lateral acceleration, the longitudinal acceleration, and/or the yaw rate of the vehicle 1, the brake control unit 130 may determine whether the electronic stability control of the vehicle 1 is likely to be performed (or executed) (or predict a likelihood of activation of an electronic stability control function).

For example, in case that the steering angle, the steering angular velocity, the lateral acceleration, the longitudinal acceleration, and/or the yaw rate are greater than predesignated reference values, the brake control unit 130 may determine that the electronic stability control is likely to be performed. Otherwise, the brake control unit 130 may determine that the electronic stability control is not likely to be performed.

For example, when the state in which the steering angle, the steering angular velocity, the lateral acceleration, the longitudinal acceleration, and/or the yaw rate are greater than the predesignated reference values is maintained for a preset reference time interval or more, the brake control unit 130 may determine that the electronic stability control is likely to be performed. Otherwise, the brake control unit 130 may determine that the electronic stability control is not likely to be performed.

On the basis of a count value made by counting the number of times the electronic stability control of the vehicle 1 is determined as being likely to be performed, the brake control unit 130 may transmit the count value to the electromechanical brake control unit 120 and/or transmit a control signal, which allows the electromechanical brake control unit 120 to control the electromechanical brake 110, to the electromechanical brake control unit 120.

On the basis of the count value made by counting the number of times the electronic stability control of the vehicle 1 is determined as being likely to be performed, the brake control unit 130 may determine the urgency level of the electronic stability control. For example, the brake control unit 130 may determine the urgency level of the electronic stability control on the basis of a count value made by counting the number of times the steering angle, the steering angular velocity, the lateral acceleration, the longitudinal acceleration, and/or the yaw rate is determined as being greater than the predesignated reference value.

For example, the urgency level of the electronic stability control may include the first level, and the second level higher in urgency than the first level.

On the basis that the count value is greater than a preset reference count value, the brake control unit 130 may determine the urgency of the electronic stability control of the vehicle 1 as the second level. Otherwise, the brake control unit 130 may determine the urgency as the first level.

On the basis of the determination of the urgency level of the electronic stability control of the vehicle 1, the brake control unit 130 may transmit the urgency level to the electromechanical brake control unit 120 and/or transmit the control signal, which allows the electromechanical brake control unit 120 to control the electromechanical brake 110, to the electromechanical brake control unit 120.

Because the brake pedal 12 and the accelerator pedal 14 do not move in case that the vehicle 1 is in a smart cruise control mode (SCC Mode), the brake control unit 130 may substitute the acceleration value and the deceleration value of the vehicle 1, which are acquired from the output data of the acceleration sensor 19-3 or the inertia measurement unit 19-5, with the output signals of the pedal displacement sensor PTS1 and the pedal displacement sensor PTS2.

The brake control unit 130 may determine a distance between the vehicle 1 and a preceding vehicle from output data of a sensing device (not illustrated), e.g., a radar, a lidar, a camera, and/or other sensors of the vehicle 1.

The brake control unit 130 may include a processor 1301 configured to provide a control signal for controlling the operation of the brake system 100.

The processor 1301 may include a memory 1303 configured to store or memorize a program (and/or an algorithm) and data for implementing an operation of controlling the brake system 100.

For example, the processor 1301 may transmit control signals to the electromechanical brake control units 121, 123, 125, and 127 to allow the electromechanical brake control units 121, 123, 125, and 127 to control the corresponding electromechanical brakes 111, 113, 115, and 117.

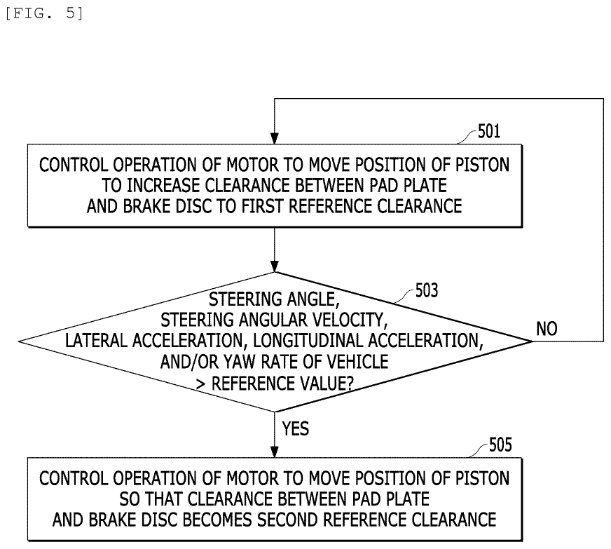

FIG. 5 is a flowchart of the operation of the brake system 100 (and/or the controller 140) according to the embodiment.

With reference to FIG. 5, the brake system 100 may control the operation of the motor MOT to move the position of the piston 170 to increase the clearance between the pad plates 161, 162, and 161′and the brake disc 10a to a preset first reference clearance (501).

In order to eliminate the drag phenomenon caused by abnormal contact between the pad plates 161, 162, and 161′ and the brake disc 10a, the brake system 100 may move the position of the piston 170 to increase the clearance between the pad plates 161, 162, and 161′ and the brake disc 10a to the first reference clearance.

For example, in the coast speed reduction situation of the vehicle 1, the brake system 100 may calculate the decelerations or accelerations of the wheels FL, RL, FR, and RR on the basis of the signals received from the wheel speed sensors 18-1, 18-3, 18-5, and 18-7 and determine whether the decelerations or accelerations of the wheels FL, RL, FR, and RR are greater than a corresponding reference value of predesignated deceleration and acceleration reference values. When the decelerations or accelerations of the wheels FL, RL, FR, and RR are greater than the corresponding reference value, the brake system 100 may determine whether the drag of the brake system 100 occurs. In case that it is determined that the drag of the brake system 100 occurs, the brake system 100 may move the position of the piston 170 to increase the clearance between the pad plates 161, 162, and 161′and the brake disc 10a to the first reference clearance.

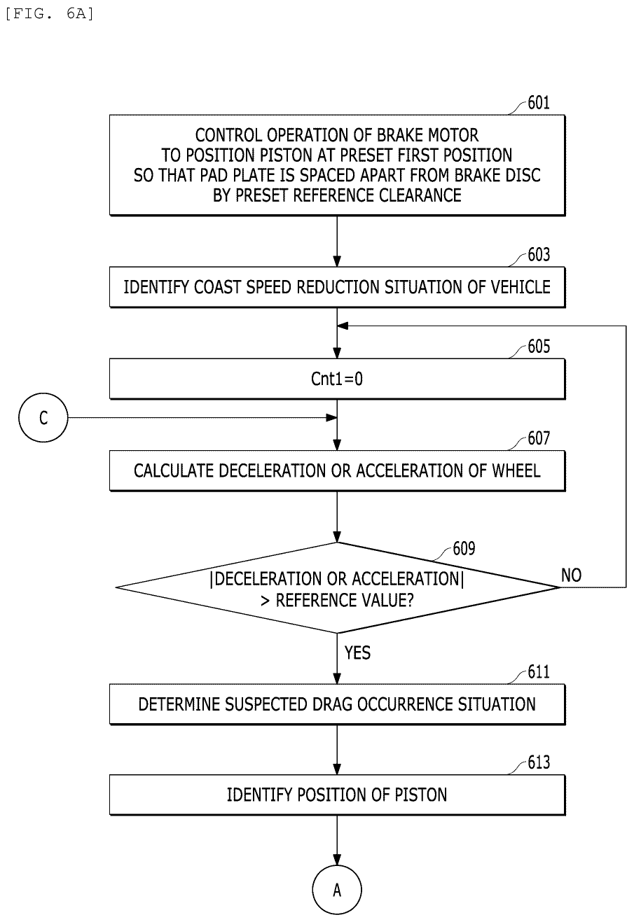

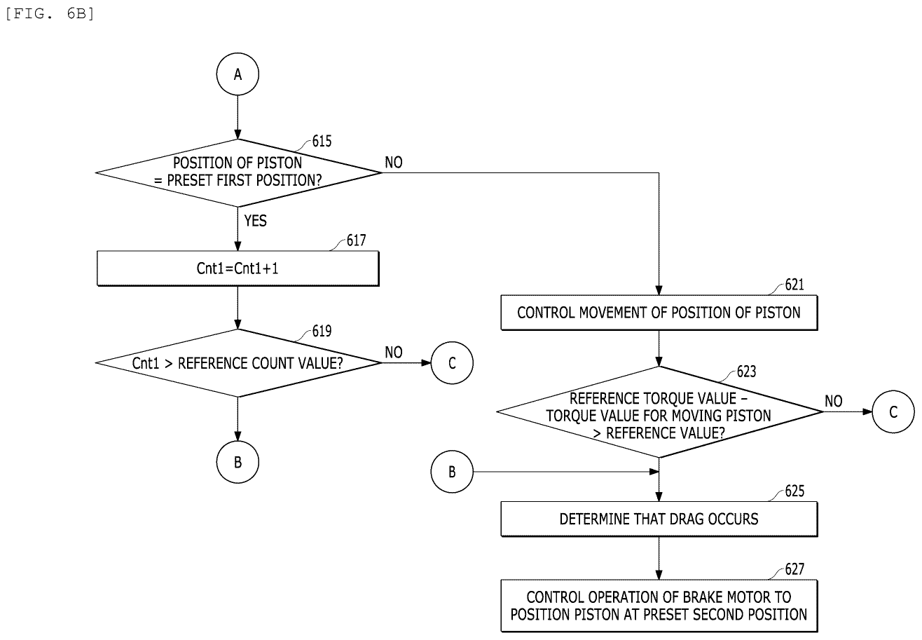

The embodiment in which the position of the piston 170 is moved to increase the clearance between the pad plates 161, 162, and 161′and the brake disc 10a to the first reference clearance will be described below with reference to FIGS. 6A and 6B.

While the position of the piston 170 is controlled to move to increase the clearance between the pad plates 161, 162, and 161′ and the brake disc 10a to the first reference clearance, the brake system 100 may determine whether the steering angle, the steering angular velocity, the lateral acceleration, the longitudinal acceleration, and/or the yaw rate of the vehicle 1 is greater than the reference value (503).

Based on the signals received from the steering sensor 19-1, the acceleration sensor 19-3, and/or the inertia measurement unit 19-5 of the vehicle 1, the brake system 100 may acquire and monitor the steering angle, the steering angular velocity, the lateral acceleration, the longitudinal acceleration, and/or the yaw rate of the vehicle 1.

In case that the steering angle, the steering angular velocity, the lateral acceleration, the longitudinal acceleration, and/or the yaw rate of the vehicle 1 is greater than the reference value, the brake system 100 may perform operation 505. Otherwise, the brake system 100 may maintain operation 501.

For example, in case that the state in which the steering angle, the steering angular velocity, the lateral acceleration, the longitudinal acceleration, and/or the yaw rate of the vehicle 1 is greater than the reference value is maintained for a preset reference time interval or more, the brake system 100 may perform operation 505. Otherwise, the brake system 100 may maintain operation 501.

The brake system 100 may control the operation of the motor MOT to move the position of the piston 170 so that the clearance between the pad plates 161, 162, and 161′and the brake disc 10a becomes a preset second reference clearance smaller than the first reference clearance (505).

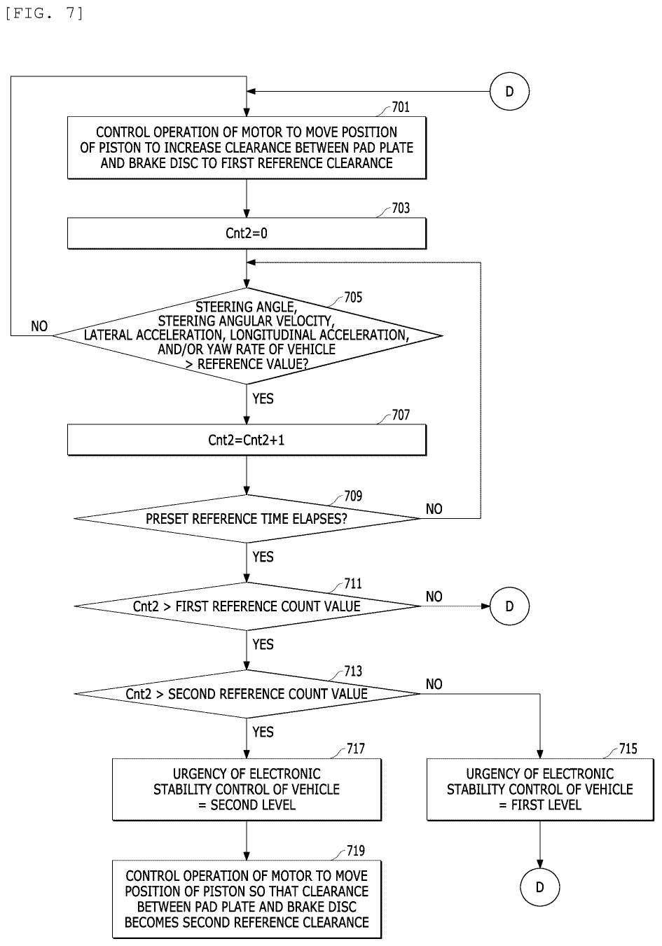

The detailed embodiment in which the position of the piston 170 is moved so that the clearance between the pad plate and the brake disc 10a becomes the second reference clearance will be described below with reference to FIG. 7.

FIGS. 6A and 6B are flowcharts of the operation of the brake system 100 (and/or the controller 140) according to the embodiment.

With reference to FIGS. 6A and 6B, the brake system 100 may control the operation of the brake motor MOT to position the piston 170 or 170′ at a preset first position so that the pad plates 161, 162, and 161′ are spaced apart from the brake disc 10a or 10a′ by a preset reference clearance during the acceleration traveling or smart cruise control of the vehicle 1 (601).

The brake system 100 may identify the coast speed reduction situation of the vehicle 1 while performing control to position the piston 170 or 170′ at the preset first position (603).

In case that the pedal effort is not applied to the brake pedal 12 and the accelerator pedal 14 by means of the output values of the pedal displacement sensor PTS1 and the pedal displacement sensor PTS2 in a state in which a gear shift is set to a drive mode, the brake system 100 may identify that the vehicle 1 is in the coast speed reduction situation.

The brake system 100 may set a count value Cnt1 to 0 (605).

The brake system 100 may calculate the decelerations or accelerations of the wheels FL, FR, RL, and RR in the coast speed reduction situation (607).

The brake system 100 may calculate the decelerations or accelerations of the wheels FL, FR, RL, and RR in the coast speed reduction situation on the basis of the signals received from the wheel speed sensors 18-1, 18-3, 18-5, and 18-7 of the wheels FL, FR, RL, and RR.

For example, the brake system 100 may determine a time section, in which no pedal effort is provided to the brake pedal 12 and the accelerator pedal 14, as a time section in the coast speed reduction situation. The brake system 100 may identify initial speeds and final speeds of the wheels FL, FR, RL, and RR in the time section of the coast speed reduction situation. The brake system 100 may calculate the decelerations or accelerations of the wheels FL, FR, RL, and RR in the coast speed reduction situation on the basis of the initial speeds and the final speeds of the wheels FL, FR, RL, and RR and the time section of the coast speed reduction situation.

The brake system 100 may determine whether an absolute value of the calculated deceleration or acceleration is greater than the predesignated reference value (609).

In case that the absolute value of the calculated deceleration oracceleration is greater than the predesignated reference value, the brake system 100 may perform operations 611 and 613. Otherwise, the brake system 100 may perform operation 605 again. For example the predesignated reference value may include a reference value for deceleration and a reference value for acceleration.

The brake system 100 may determine a suspected drag occurrence situation (611).

The brake system 100 may identify the position of the piston 170 or 170′ (613).

The brake system 100 may determine whether the position of the piston 170 or 170′ is the preset first position (615).

In case that the position of the piston 170 or 170′ is the preset first position, the brake system 100 may perform operation 617. Otherwise, the brake system 100 may perform operation 621.

The brake system 100 may increase the count value Cnt1 by 1 (617).

The brake system 100 may determine whether the count value Cnt1 is greater than a predesignated reference count value (619).

As the temperature decreases, the deceleration and/or acceleration of the vehicle 1 further decreases, and the drag is caused by the temperature during the coast speed reduction (gear shift=shift position D), which may affect the deceleration and/or acceleration of the vehicle 1. In addition, the drag may be repeatedly caused by the temperature even though the piston 170 or 170′ of the vehicle 1 is positioned at the preset first position. In consideration of this configuration, the operation of determining whether the count value Cnt1 is greater than the reference count value is performed.

In case that the count value is greater than the reference count value, the brake system 100 may perform operation 625. Otherwise, the brake system 100 may perform operation 607.

The brake system 100 may perform control to move the position of the piston 170 or 170′ to move the position of the piston 170 or 170′ to the preset first position (621).

The brake system 100 may determine whether a value made by subtracting torque, which is generated to move the piston 170 or 170′ at operation 621, from a predesignated reference torque value is greater than a predesignated reference value (623).

Based on a fixed speed of the vehicle 1, in a normal situation in which no drag occurs, i.e., in case that the piston 170 or 170′ is positioned at the preset first position so that the pad plates 161, 162, and 161′ of each of the electromechanical brakes 111, 113, 115, and 117 are spaced apart from the brake disc 10a or 10a′ by the preset reference clearance, the torque (pad clearance Tq), which is generated by the brake motor MOT, may be continuously maintained as a predetermined value to maintain the predetermined clearance between the pad plates 161, 162, and 161′ and the brake disc 10a or 10a′.

In contrast, in the drag occurrence situation, the torque (pad clearance Tq), which is generated by the brake motor MOT, may be increased to maintain the predetermined clearance between the pad plates 161, 162, and 161′and the brake disc 10a or 10a′.

Therefore, the torque (pad clearance Tq), which is generated by the brake motor MOT for each speed of the vehicle 1 in the normal situation in which no drag occurs, may be set to the reference torque value, and whether the drag occurs may be determined by comparing the torque, which is generated by the brake motor MOT to control and move the piston 170 or 170′ at operation 621, with the reference torque value.

In case that the value made by subtracting a torque value, which is generated to move the piston 170 or 170′ at operation 621, from the predesignated reference torque value is greater than the predesignated reference value, the brake system 100 may perform operations 625 and 627. Otherwise, the brake system 100 may perform operation 607.

The brake system 100 may determine that the drag has occurred (625).

In response to the determination that the drag has occurred, the brake system 100 may control the operation of the brake motor MOT to position the piston 170 or 170′ at a preset second position so that the pad plates 161, 162, and 161′ are spaced apart from the brake disc 10a or 10a′ by the preset first reference clearance (627).

For example, in response to the determination that the drag has occurred, the brake system 100 may control the operation of the brake motor M to move the position of the piston 170 or 170′ so that the clearance between the pad plates 161, 162, and 161′ and the brake disc 10a or 10a′ increases to the first reference clearance.

For example, in the related art, the brake system 100 performs control so that the pad plates 161, 162, and 161′ are spaced apart from the brake disc 10a or 10a′ by 0.05 to 0.5 mm. However, in the drag occurrence situation, the brake system 100 may be modified to perform control so that the pad plates 161, 162, and 161′ are spaced apart from the brake disc 10a or 10a′ by 0.1 to 0.5 mm.

According to the embodiment in FIGS. 6A and 6B, in case that the drag phenomenon is caused by the high-speed traveling of the vehicle 1 or by external factors even though the position of the piston 170 or 170′ is spaced apart, by a predetermined distance, from the position at which the pad plates 161, 162, and 161′ come into contact with the brake disc 10a or 10a′, the brake system 100 may recognize this situation and solve the problem of the occurrence of the drag phenomenon.

FIG. 7 is a flowchart of the operation of the brake system 100 (and/or the controller 140) according to the embodiment.

With reference to FIG. 7, the brake system 100 may control the operation of the motor M to move the position of the piston 170 to increase the clearance between the pad plates 161, 162, and 161′ and the brake disc 10a to the preset first reference clearance (701).

The brake system 100 may set a count value Cnt2 to 0 (703).

The brake system 100 may determine whether the steering angle, the steering angular velocity, the lateral acceleration, the longitudinal acceleration, and/or the yaw rate of the vehicle 1 is greater than a predesignated reference value (705).

For example, the brake system 100 may determine whether the steering angle, the steering angular velocity, the lateral acceleration, the longitudinal acceleration, and/or the yaw rate of the vehicle 1 is greater than the predesignated reference value for each preset time cycle while performing first operation control on the motor M.

In case that the steering angle, the steering angular velocity, the lateral acceleration, the longitudinal acceleration, and/or the yaw rate of the vehicle 1 is greater than the predesignated reference value, the brake system 100 may determine that the electronic stability control of the vehicle 1 is likely to be performed (or executed). Otherwise, the brake system 100 may determine that the electronic stability control of the vehicle 1 is not likely to be performed.

In case that the steering angle, the steering angular velocity, the lateral acceleration, the longitudinal acceleration, and/or the yaw rate of the vehicle 1 is determined as being greater than the predesignated reference value, e.g., the electronic stability control of the vehicle 1 is determined as being likely to be performed, the brake system 100 may perform operation 707. Otherwise, the brake system 100 may maintain operation 701.

The brake system 100 may increase the count value Cnt2 by 1 (707).

On the basis of operation 705 or 707, the brake system 100 may determine whether a preset reference time has elapsed (709).

For example, the brake system 100 may determine whether the preset reference time has elapsed after the time point at which operation 705 or 707 has been performed.

For example, the reference time may be a time preset to determine whether there is a problem with the stability of the vehicle 1 because of excessive cornering and/or swaying of the vehicle 1 when the state in which the steering angle, the steering angular velocity, the lateral acceleration, the longitudinal acceleration, and/or the yaw rate of the vehicle 1 is greater than the reference value is maintained for a predetermined time.

In case that the reference time has elapsed, the brake system 100 may perform operation 711. Otherwise, the brake system 100 may perform operation 705. For example, in case that the reference time does not elapse from a time point at which operation 705 is performed, the brake system 100 may perform operation 705 again in a preset time cycle.

The brake system 100 may determine whether the count value Cnt2 is greater than the first reference count value (711).

When the count value Cnt2 is greater than the first reference count value, the excessive cornering and/or swaying of the vehicle 1 may be maintained for a predetermined time. Therefore, in case that the count value Cnt2 is greater than the first reference count value, the brake system 100 may determine that the electronic stability control of the vehicle 1 is likely to be performed.

In case that the count value Cnt2 is greater than the first reference count value, e.g., the electronic stability control of the vehicle 1 is likely to be performed, the brake system 100 may perform operation 713. Otherwise, the brake system 100 may maintain operation 701.

The brake system 100 may determine whether the count value Cnt2 is greater than a preset second reference count value that is a value greater than the first reference count value (713).

The second reference count value may be used to determine the urgency of the electronic stability control of the vehicle 1.

In case that the count value Cnt2 is greater than the second reference count value, the brake system 100 may perform operation 717. Otherwise, the brake system 100 may perform operation 715.

The brake system 100 may determine the urgency of the electronic stability control of the vehicle 1 as the first level (715).

The brake system 100 may maintain operation 701 in response to the determination that the urgency of the electronic stability control of the vehicle 1 is the first level.

The brake system 100 may determine the urgency of the electronic stability control of the vehicle 1 as the second level higher than the first level (717).

In response to the determination that the urgency of the electronic stability control of the vehicle 1 is the second level, the brake system 100 may control the operation of the motor M to move the position of the piston 170 so that the clearance between the pad plates 161, 162, and 161′ and the brake disc 10a becomes the preset second reference clearance (719).

In addition to the above-mentioned embodiment in FIG. 7, the brake system 100 may perform braking control for the electronic stability control of the vehicle 1 after operation 719.

According to the above-mentioned embodiment in FIG. 7, the brake system 100 may ensure the responsiveness of the electronic stability control of the vehicle 1 by the clearance between the pad plates 161, 162, and 161′and the brake disc 10a or 10a′.

For example, in the situation in which the clearance between the pad plates 161, 162, and 161′and the brake disc 10a or 10a′ increases, the brake system 100 may predict the likelihood that the electronic stability control of the vehicle 1 is performed, and the brake system 100 may perform control to decrease the clearance between the pad plates 161, 162, and 161′ and the brake disc 10a or 10a′ in case that the electronic stability control of the vehicle 1 is likely to be performed. In addition, the brake system 100 may differently control the clearance between the pad plates 161, 162, and 161′ and the brake disc 10a or 10a′ in accordance with the urgency of the electronic stability control of the vehicle 1.

Meanwhile, the brake system 100 and the method of controlling the same according to the above-mentioned embodiments may provide the technology capable of ensuring the quick braking responsiveness in the situation in which the braking stability of the vehicle is required regardless of the braking intention of the vehicle driver while the control is performed to zeroize the occurrence of a drag phenomenon caused by abnormal contact between the brake disc 10a and the pad plates 161, 162, and 161′ of each of the electromechanical brakes 111, 113, 115, and 117.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. A brake system comprising:
a piston configured to advance or retract and configured to press a pad plate so that the pad plate is in contact with a brake disc configured to rotate together with a wheel;
a motor configured to generate a rotational force for operating the piston;
a ball screw configured to convert a rotational motion of the motor into a rectilinear motion to operate the piston; and
a controller configured to control the motor,
wherein the controller is configured to control the motor to move a position of the piston to increase a clearance between the pad plate and the brake disc to a first reference clearance, and
control the motor to move the position of the piston to decrease the clearance to a second reference clearance smaller than the first reference clearance on the basis that at least one of a steering angle, a steering angular velocity, a lateral acceleration, a longitudinal acceleration, or a yaw rate of the vehicle is greater than a predesignated reference value.

2. The brake system of claim 1, wherein the controller is configured to control the motor to move the position of the piston to increase the clearance to the first reference clearance on the basis that a deceleration or an acceleration of the wheel, which is acquired from a signal received from a wheel speed sensor of the wheel, is greater than a corresponding reference value of predesignated deceleration and acceleration reference values in a coast speed reduction situation of the vehicle.

3. The brake system of claim 2, wherein the controller is configured to control the motor to move the position of the piston to increase the clearance to the first reference clearance based on determination of a drag occurrence of the brake system when the deceleration or the acceleration of the wheel is greater than the corresponding reference value.

4. The brake system of claim 1, wherein the controller is configured to control the motor to move the position of the piston to decrease the clearance to the second reference clearance on the basis that the state in which at least one of the steering angle, the steering angular velocity, the lateral acceleration, the longitudinal acceleration, or the yaw rate of the vehicle is greater than the reference value is maintained for a reference time interval or more.

5. The brake system of claim 4, wherein the controller is configured to determine that electronic stability control of the vehicle is likely to be performed on the basis that at least one of the steering angle, the steering angular velocity, the lateral acceleration, the longitudinal acceleration, or the yaw rate of the vehicle is greater than the reference value.

6. The brake system of claim 4, wherein the controller is configured to increase a count value on the basis that at least one of the steering angle, the steering angular velocity, the lateral acceleration, the longitudinal acceleration, or the yaw rate of the vehicle is greater than the reference value during control of the motor to move the position of the piston to increase the clearance to the first reference clearance, and
control the motor to move the position of the piston to decrease the clearance to the second reference clearance on the basis of the increased count value.

7. The brake system of claim 6, wherein the controller is configured to control the motor to move the position of the piston to decrease the clearance to the second reference clearance on the basis that the increased count value is greater than a predesignated first reference count value, and
control the motor to move the position of the piston on the basis of a deceleration or acceleration of the wheel acquired from a signal received from a wheel speed sensor of the wheel on the basis that the increased count value is equal to or smaller than the predesignate first reference count value.

8. The brake system of claim 7, wherein the controller is configured to control the motor to maintain the clearance as the first reference clearance on the basis that the increased count value is greater than a predesignated second reference count value that is a value greater than the predesignate first reference count value, and
control the motor to move the position of the piston to decrease the clearance to the second reference clearance on the basis that the increased count value is greater than the predesignate first reference count value and equal to or smaller than the predesignate second reference count value.

9. The brake system of claim 7, wherein the controller is configured to determine urgency of the electronic stability control as a first level on the basis that the increased count value is greater than the predesignated first reference count value and equal to or smaller than a predesignated second reference count value, and
determine the urgency of the electronic stability control of the vehicle as a second level higher than the first level on the basis that the increased count value is greater than the predesignated second reference count value that is a value greater than the predesignate first reference count value.

10. The brake system of claim 9, wherein the controller is configured to control the motor to maintain the clearance as the first reference clearance on the basis that the urgency of the electronic stability control of the vehicle is determined as the second level, and
control the motor to move the position of the piston to decrease the clearance to the second reference clearance on the basis that the urgency of the electronic stability control of the vehicle is determined as the first level.

11. A method of controlling a brake system, the method comprising:
controlling a motor of an electromechanical brake to move a position of a piston of the electromechanical brake to increase a clearance between a pad plate and a brake disc of the electromechanical brake to a first reference clearance; and
controlling the motor to move the position of the piston to decrease the clearance to a second reference clearance smaller than the first reference clearance on the basis that at least one of a steering angle, a steering angular velocity, a lateral acceleration, a longitudinal acceleration, or an yaw rate of the vehicle is greater than a predesignated reference value.

12. The method of claim 11, wherein the controlling of the motor to move the position of the piston to increase the clearance to the first reference clearance is performed on the basis that a deceleration or an acceleration of a wheel acquired from a signal received from a wheel speed sensor of the wheel is greater than a corresponding reference value of predesignated deceleration and acceleration reference values in a coast speed reduction situation of the vehicle.

13. The method of claim 12, wherein the controlling of the motor to move the position of the piston to increase the clearance to the first reference clearance is performed on the basis that a drag occurrence of the brake system when the deceleration or the acceleration of the wheel is greater than the corresponding reference value.

14. The method of claim 11, wherein the controlling of the motor to move the position of the piston to decrease the clearance to the second reference clearance is performed on the basis that the state in which at least one of the steering angle, the steering angular velocity, the lateral acceleration, the longitudinal acceleration, or the yaw rate of the vehicle is greater than the reference value is maintained for a preset time interval or more.

15. The method of claim 14, further comprising:
determining that electronic stability control of the vehicle is likely to be performed on the basis that at least one of the steering angle, the steering angular velocity, the lateral acceleration, the longitudinal acceleration, or the yaw rate of the vehicle is greater than the reference value.

16. The method of claim 14, wherein the controlling the motor to move the position of the piston to decrease the clearance to the second reference clearance comprises:
increasing a count value on the basis that at least one of the steering angle, the steering angular velocity, the lateral acceleration, the longitudinal acceleration, or the yaw rate of the vehicle is greater than the reference value during control of the motor to move the position of the piston to increase the clearance to the first reference clearance; and
controlling the motor to move the position of the piston so that the clearance becomes the second reference clearance on the basis of the increased count value.

17. The method of claim 16, wherein the controlling the motor to move the position of the piston to decrease the clearance to the second reference clearance is performed on the basis that the increased count value is greater than a predesignated first reference count value, and
wherein the method of controlling the brake system further comprises controlling the motor to move the position of the piston on the basis of a deceleration or acceleration of a wheel acquired from a signal received from a wheel speed sensor of the wheel on the basis that the increased count value is equal to or smaller than the predesignated first reference count value.

18. The method of claim 17, further comprising:
controlling the motor to maintain the clearance as the first reference clearance on the basis that the increased count value is greater than a predesignated second reference count value that is a value greater than the first reference count value,
wherein the controlling the motor to move the position of the piston to decrease the clearance to the second reference clearance is performed on the basis that the increased count value is greater than the predesignate first reference count value and equal to or smaller than the predesignate second reference count value.

19. The method of claim 17, further comprising:
determining urgency of the electronic stability control as a first level on the basis that the increased count value is greater than the predesignate first reference count value and equal to or smaller than a predesignated second reference count value; and
determining the urgency of the electronic stability control of the vehicle as a second level higher than the first level on the basis that the increased count value is greater than the predesignated second reference count value that is a value greater than the predesignate first reference count value.

20. The method of claim 19, further comprising:
controlling the motor to maintain the clearance as the first reference clearance on the basis that the urgency of the electronic stability control of the vehicle is determined as the second level,
wherein the controlling the motor to move the position of the piston to decrease the clearance to the second reference clearance is performed on the basis that the urgency of the electronic stability control of the vehicle is determined as the first level.
